(19) United States
(12) Patent Application Publication
(10) Pub. No.: US 2022/0147615 A1
(43) Pub. Date: May 12, 2022

(54) DATA PROCESSING DEVICE, DATA PROCESSING METHOD, AND PROGRAM

(71) Applicant: Mitsubishi Electric Corporation, Toyota (JP)

(72) Inventor: Osamu NASU, Tokyo (JP)

(73) Assignee: Mitsubishi Electric Corporation, Tokyo (JP)

(21) Appl. No.: 17/605,581

(22) PCT Filed: Jun. 13, 2019
(86) PCT No.: PCT/JP2019/023448

§ 371 Date: Oct. 22, 2021

(51) Int. Cl. G06F 21/52; G06F 21/64

(52) U.S. Cl. CPC G06F 21/52; G06F 2221/034; G06F 21/64

(57) ABSTRACT

A data processing apparatus (10) includes a receiver (120), a storage (141), a determiner (142), and a flow controller (143). The receiver (120) receives a setting for data processing to be executed with respect to data. The storage (141) stores setting information indicating the setting received by the receiver (120). The determiner (142) determines whether a first validity is present for the setting information and whether a second validity relating to a processing unit (130) for execution of the data processing is present. The flow controller (143) transmits data to the processing unit (130) and a collection processing unit (160) when the determiner (142) determines that the first validity is present and the second validity is present, thereby causing the processing unit (130) and the collection processing unit (160) to execute the data processing.

### TECHNICAL FIELD

The present disclosure relates to a data processing apparatus, a data processing method, and a program.

### BACKGROUND ART

In a facility, such as a factory, processing with respect to data collected in real time from the facility is widely performed to achieve a production process, inspection process, and other various types of processes. Content of the processing to be executed with respect to this data is set to meet the needs of a workplace. A validity of the processing to be executed is preferably ensured in anticipation that there may be unexpected contingencies such as tampering with the content of the set processing, data corruption due to a trouble in a device, and insufficient checking for content of data alteration in accordance with authorization level of the setter. Thus, utilizing a technique for verifying tampering of data as means for ensuring a validity of processing to be executed is conceivable (refer to, for example, Patent Literature 1).

Patent Literature 1 discloses a technique by which secret information including a program to be applied to data processing to be executed in a security function module arranged in an MPU chip is encrypted with a device key stored in the module, is granted a falsification verification value, and is stored in external storage means. This technique enables verification of tampering with the program that is utilized by the module in the MPU chip.

### CITATION LIST

### Patent Literature

Patent Literature 1: Unexamined Japanese Patent Application Publication No. 2005-227995

### SUMMARY OF INVENTION

### Technical Problem

Although the technique disclosed in Patent Literature 1 enables verification of alteration of a program, in order to ensure a validity of content of processing, ensuring a validity is necessary not only for alteration of a program but also for setting information to be set for the program. For example, a case exists in which multiple programs are prepared in advance, data is provided to a program that is selected, based on a setting by a user, from among the programs, and the program executes the data. In such a case, even when the technique disclosed in Patent Literature 1 is used and the program is verified as not having been altered, the setting may possibly be rewritten to execute a program other than the program that the user intends to execute. Further, the same setting does not always lead to attainment of a result desired by the user, since the setting may possibly cause process of data by a program that has a name indicated by the setting but is different from the program that the user intends to execute. Thus, there is a room for more reliable ensuring of a validity of processing to be executed with respect to data.

The present disclosure is made in view of the aforementioned circumstances, and an objective of the present disclosure is to enable more reliable ensuring of a validity of processing to be executed with respect to data.

### Solution to Problem

To achieve the aforementioned objective, a data processing apparatus of the present disclosure includes:

reception means for receiving a setting for data processing to be executed with respect to data;

storage means for storing setting information that includes information indicating the setting received by the reception means;

determination means for determining (i) whether a first validity is present for the setting information and (ii) whether a second validity relating to processing means for execution of the data processing is present; and

control means for transmitting data to the processing means when the determination means determines that the first validity is present and the second validity is present, thereby causing the processing means to execute the data processing.

### Advantageous Effects of Invention

According to the present disclosure, the determination means determines whether the first validity is present for the setting information and determines whether the second validity relating to the processing means is present. Due to this configuration, even in a case in which alteration is made for content of data processing while a state of ensuring one validity of the first validity or the second validity is maintained, a determination on whether the other validity of the first validity or the second validity is present is made, thereby ensuring the validity of the content of the processing. This enables more reliable ensuring of a validity of processing to be executed with respect to data.

### BRIEF DESCRIPTION OF DRAWINGS

FIG. 1 is a block diagram illustrating configuration of a data processing system according to Embodiment 1 of the present disclosure;

FIG. 2 illustrates hardware configuration of a data processing apparatus according to Embodiment 1;

FIG. 3 illustrates an example of a setting for data processing according to Embodiment 1;

FIG. 4 illustrates functional configuration of the data processing apparatus according to Embodiment 1;

FIG. 5 schematically illustrates configuration of setting information according to Embodiment 1;

FIG. 6 illustrates in a table format the configuration of the setting information according to Embodiment 1;

FIG. 7 is a flowchart illustrating setting processing according to Embodiment 1;

FIG. 8 is a flowchart illustrating authentication processing according to Embodiment 1;

FIG. 9 illustrates a first example of invalid data processing detected by the data processing apparatus according to Embodiment 1;

FIG. 10 illustrates a second example of the invalid data processing detected by the data processing apparatus according to Embodiment 1;

FIG. 11 is a diagram for explanation of the invalid data processing detected by the data processing apparatus according to Embodiment 1;

FIG. 12 is a flowchart of input processing according to Embodiment 2;

FIG. 13 is a flowchart of setting processing according to Embodiment 2;

FIG. 14 illustrates configuration of a data processing apparatus according to a modified example; and

FIG. 15 illustrates data processing according to another modified example.

### DESCRIPTION OF EMBODIMENTS

Hereinafter, a data processing apparatus 10 according to an embodiment of the present disclosure is described in detail with reference to the drawings.

### Embodiment 1

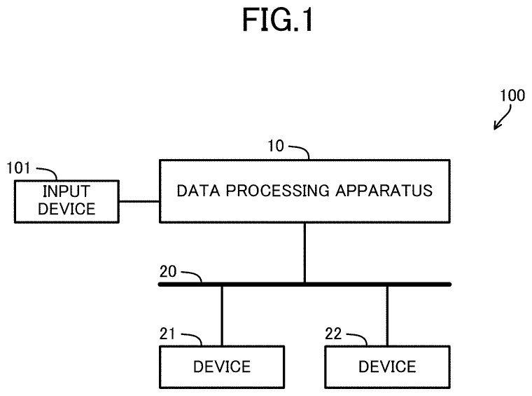

A data processing apparatus 10 according to the present embodiment is, for example, an industrial personal computer (IPC) arranged in a factory. As illustrated in FIG. 1, the data processing apparatus 10 connects, via an industrial network 20, to devices 21 and 22 arranged on a production line of a factory, and connects to an input device 101 for inputting a setting for processing of data. The data processing apparatus 10, the input device 101, and the devices 21 and 22 are included in a data processing system 100 as a factory automation (FA) system. The data processing apparatus 10 executes processing of data collected from the device 21 via the network 20 and outputs, to the device 22, a control command according to a result of the processing. The device 21 is a sensor, and the device 22 is an actuator or a robot.

With regard to content of data processing by the data processing apparatus 10, different content is set for different requests of a workplace. The data processing apparatus 10 evaluates a validity of the set content of processing, thereby ensuring that no alteration is made for the content of processing after setting of the content of the processing and until execution of the processing. The subject of the evaluation by the data processing apparatus 10 may be appropriateness, reliability, integrity, accuracy, or effectiveness of the content of processing. Examples of alteration of the content of processing include malicious tampering by a third party, an unintended modification such as faulty operation of the data processing apparatus 10 by a user, and corruption of data indicating content of processing due to malfunction of the data processing apparatus 10.

The validity ensured by the data processing apparatus 10 means that processing to be executed is processing that is intended to be executed by operation of the data processing apparatus 10. For example, in the case in which content of processing is rewritten by a malicious third party, the rewritten content of processing is different from that intended to be executed by the operation, leading to lack of the validity. In the case in which setting of content of processing is not performed appropriately due to malfunction of the data processing apparatus 10, processing that is actually executed is different from intended processing, leading to lack of the validity.

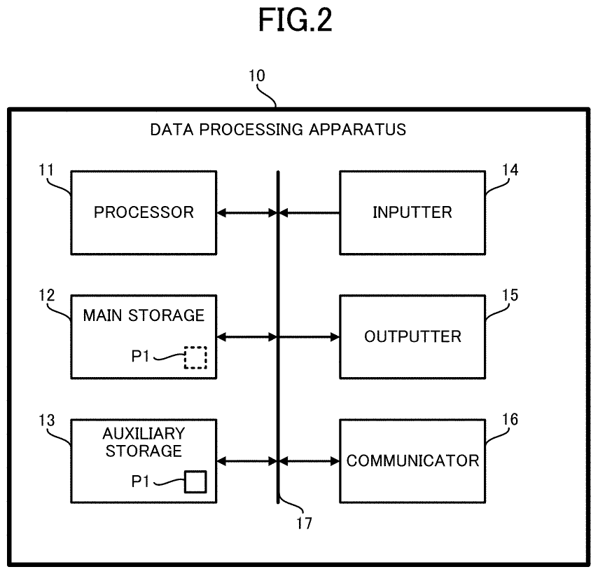

As illustrated in FIG. 2, the data processing apparatus 10 includes, as hardware components, a processor 11, a main storage 12, an auxiliary storage 13, an inputter 14, an outputter 15, and a communicator 16. The main storage 12, the auxiliary storage 13, the inputter 14, the outputter 15, and the communicator 16, are connected to the processor 11 via an internal bus 17.

The processor 11 includes a central processing unit (CPU). The processor 11 executes a program P1 stored in the auxiliary storage 13 to achieve various types of functions of the data processing apparatus 10, thereby executing processing described later.

The main storage 12 includes random access memory (RAM). The program P1 is loaded from the auxiliary storage 13 into the main storage 12. The main storage 12 is used by the processor 11 as a work area.

The auxiliary storage 13 includes a nonvolatile memory such as an electrically erasable programmable read-only memory (EEPROM) and a hard disk drive (HDD). The auxiliary storage 13 stores the program P1 and various types of data used for processing by the processor 11. The auxiliary storage 13 supplies, in accordance with instructions from the processor 11, to the processor 11 data to be used by the processor 11 and stores data supplied from the processor 11. Although FIG. 2 illustrates in a representative manner only one program, that is, the program P1, the auxiliary storage 13 may store multiple programs, and multiple programs may be loaded into the main storage 12.

The inputter 14 includes an input device such as input keys and a pointing device. The inputter 14 acquires information inputted by a user of the data processing apparatus 10 and sends notification of the acquired information to the processor 11.

The outputter 15 includes an output device such as a liquid crystal display (LCD) and a speaker. The outputter 15 presents various types of information to the user in accordance with instructions from the processor 11.

The communicator 16 includes a network interface circuit for communication with an external device. The communicator 16 receives a signal from the exterior and outputs data indicated by the signal to the processor 11. Further, the communicator 16 transmits to the external device a signal indicating data outputted from the processor 11.

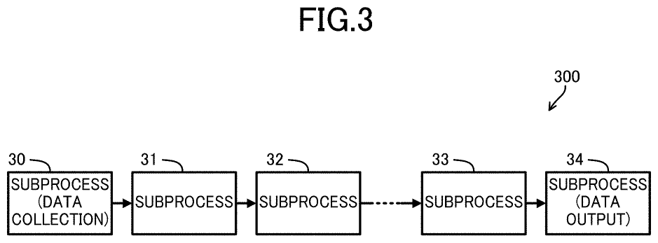

The data processing apparatus 10 achieves various types of functions, including data processing, by cooperation among the hardware components illustrated in FIG. 2. The data processing executed by the data processing apparatus 10 is freely defined by the user as data processing 300 that includes a series of subprocesses 30, 31, 32, 33, and 34, as illustrated in FIG. 3.

The data processing 300 is a process flow that includes the subprocesses 30-34 that are sequentially executed with respect to the data outputted from the device 21. Specifically, the data processing 300 is achieved by executing, in order, the subprocess 30 of collecting data for which the data processing 300 is to be executed, the subprocesses 31-33, and the subprocess 34 of outputting data indicating a result of the data processing 300. The arrows illustrated in FIG. 3 each indicate transmission of data that is a target of a corresponding subprocess. For example, data acquired from the exterior of the data processing apparatus 10 by executing the subprocess 30 is inputted into the subprocess 31, and then the subprocess 31 is executed with respect to this data. Further, data indicating a result of processing executed in the subprocess 31 is outputted from subprocess 31 and inputted into the subprocess 32, and then the subprocess 32 is executed with respect to this data. Further, data indicating a result of processing executed in the subprocess 33 is outputted from the subprocess 33, becomes a processing target of the subprocess 34, and then is outputted to the exterior of the data processing apparatus 10.

The subprocess 30 corresponds to processing for collecting data by receiving a signal from the device 21 via the network 20 illustrated in FIG. 1. Since the device 21 periodically transmits data indicating a sensing result, the subprocess 30 is executed periodically, for example, with a period of 10 milliseconds, a 100 milliseconds, or one second. The data indicating the sensing result is, for example, an 8 bit or 16 bit digital value.

Each of the subprocesses 31-33 is processing that is executed repeatedly in response to execution of the subprocess 30. The subprocesses 31-33 are respectively, for example, processing for calculating a moving average, determination processing for determining whether a value of the processing target is higher than a predetermined threshold value, and processing for determining content of the control command to the device 22 illustrated in FIG. 1. These subprocesses 31-33 enable outputting of a specific control command only when a value obtained by removing noise from the sensing result by the moving average is higher than the threshold value.

The subprocesses 31-33 are not limited to the aforementioned processing. For example, the subprocesses 31-33 may be rounding-off processing or normalization processing for setting a value within a predetermined range, scaling processing for multiplying an input value by a predetermined constant, shift processing for adding a predetermined offset value, filtering processing or statistical processing that are different from the moving average calculation processing, conversion processing such as fast Fourier transform (FFT), other processing treatment or diagnostic processing, or other processing.

The subprocess 34 corresponds to processing for transmitting the result of processing in subprocess 33 to the device 22 via the network 20 illustrated in FIG. 1. The subprocess 34 is not limited to transmitting data to the device 22, and may be outputting a command to execute a predesignated program, displaying on a screen the result of execution of the data processing 300, transmitting information to another device, or other output processing. Hereinafter, an example is mainly described in which data obtained by execution of the data processing 300 is outputted as the control command to the device 22.

Each of the subprocesses 30-34 is executed sequentially in response to data that is sequentially inputted. For example, the subprocesses 30-34 are executed, in order, with respect to one data, and then the subprocesses 30-34 are executed, in order, with respect to the next data. The subprocesses 30-34 that are executed with respect to the one data and the subprocesses 30-34 that are executed with respect to the next data are executed in parallel. In other words, the data processing 300 with respect to the next data is started prior to completion of the data processing 300 with respect to the one data. However, this configuration is not limiting, and the data processing 300 may be executed sequentially. Further, although FIG. 3 illustrates in a representative manner five subprocesses, that is, the subprocesses 30-34, the data processing 300 may include four or less subprocesses, or may include six or more subprocesses.

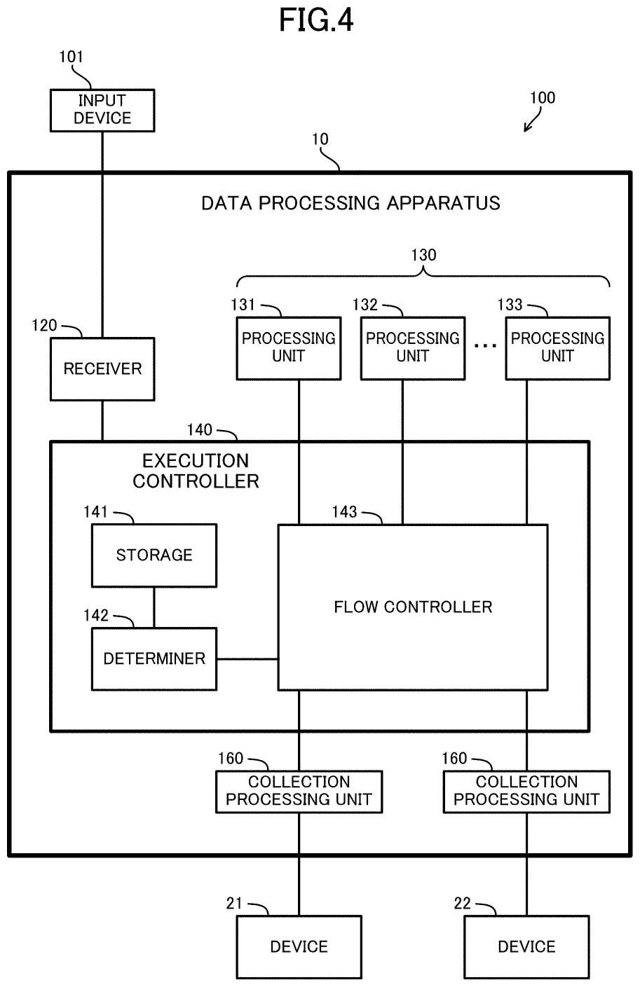

To execute the data processing 300 illustrated in FIG. 3, the data processing apparatus 10 functionally includes the elements as illustrated in FIG. 4. Specifically, the data processing apparatus 10 includes a receiver 120 that receives a setting for data processing, processing units 131, 132, and 133 that execute the data processing by executing the subprocesses, an execution controller 140 that performs control for execution of the data processing, and collection processing units 160 that perform collection of data and outputting of the control command.

The receiver 120 is mainly achieved by the processor 11. The receiver 120 receives the setting for the data processing that defines the subprocesses to be sequentially executed with respect to data. The receiver 120 sends notification of the setting for the data processing to the execution controller 140. The receiver 120 is an example of reception means, included in the data processing apparatus 10, for receiving the setting for the data processing 300 to be executed with respect to data.

Each of the processing units 131-133 is mainly achieved by cooperation between the processor 11 and the main storage 12 and executes a corresponding subprocess of the subprocesses 31-33. Specifically, each of the processing units 131-133 is achieved by execution by the processor 11 of a software module stored in the auxiliary storage 13. This software module may be plug-in software that the user stores in the auxiliary storage 13. Further, this plug-in software may be software designed by the user, software purchased by the user, or open-source software obtained by the user. Hereinafter, the processing units 131-133 are each referred to as the processing unit 130. The processing unit 130 corresponds to a first example of processing means, included in the data processing apparatus 10, for executing data processing.

The processing units 130 do not necessarily have a one-to-one correspondence to the subprocesses included in the data processing 300 illustrated in FIG. 3. Thus when, for example, the same subprocess is to be executed two times in a row on the data and the two subprocesses are concatenated in the data processing 300, these subprocesses may be executed by the single processing unit 130.

The execution controller 140 is mainly achieved by cooperation between the processor 11 and the main storage 12. The execution controller 140 mediates the passing of data among the processing unit 130 and the other processing units 130 and mediates the passing of data among the collection processing units 160 and the processing units 130, thereby causing the processing units 130 and the collection processing units 160 to execute the subprocesses, in an order corresponding to data processing that is set. The execution controller 140 includes: a storage 141 that stores setting information indicating the setting for the data processing; a determiner 142 that, when the data processing is executed, determines whether a validity relating to the setting information is present; and a flow controller 143 that determines, based on the setting information, subprocesses to be executed with respect to data, thereby controlling a data flow.

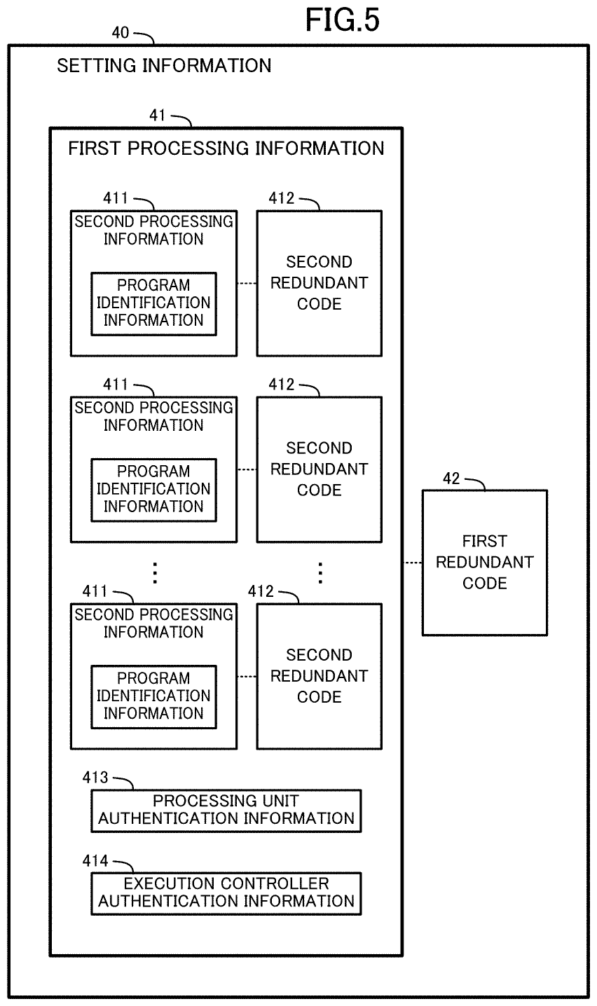

The storage 141 is an example of storage means, included in the data processing apparatus 10, for storing the setting information that includes information indicating the setting received by the receiver 120. The storage 141 stores setting information 40 as illustrated in FIG. 5. The setting information 40 includes first processing information 41 indicating the setting for data processing that is received by the receiver 120, and a first redundant code 42 corresponding to the first processing information 41. The first redundant code 42 is a code for verification of a validity of the first processing information 41 and is, for example, a checksum of the first processing information 41, an error-detecting code such as Cyclic Redundancy Check-32 (CRC32), or a hash value. The receiver 120 calculates the first redundant code 42 from the first processing information 41.

The first processing information 41 includes pieces of second processing information 411 that each relate to a corresponding one of the processing units 130 or the collection processing units 160 for execution of data processing, second redundant codes 412 corresponding to the pieces of the second processing information 411, processing unit authentication information 413 for authenticating that the processing units 130 have authenticity, and execution controller authentication information 414 for authenticating that the execution controller 140 itself has authenticity.

Each of the pieces of the second processing information 411 is information that indicates (i) a type of a subprocess to be executed by a corresponding one of the processing units 130 or the collection processing units 160, (ii) execution data for execution of the subprocess, (iii) an order-of-execution in which the subprocess is to be executed, and (iv) details of the subprocess. The execution data indicates, for, example, location of a software module for execution of the subprocess. The second redundant codes 412 are codes for verifying, based on the pieces of the second processing information 411, a validity relating to the processing units 130 and the collection processing units 160 for execution of the subprocesses and that each are, for example, a checksum of the software module for which location is indicated by a corresponding piece of the second processing information 411, an error-detecting code such as CRC32, a message authentication code, or a hash value. Each of the second redundant codes 412 is calculated by the receiver 120 from binary data that is an object file serving as the software module. That is to say, the second redundant codes 412 are calculated from programs for achievement of the processing units 130 and the collection processing units 160.

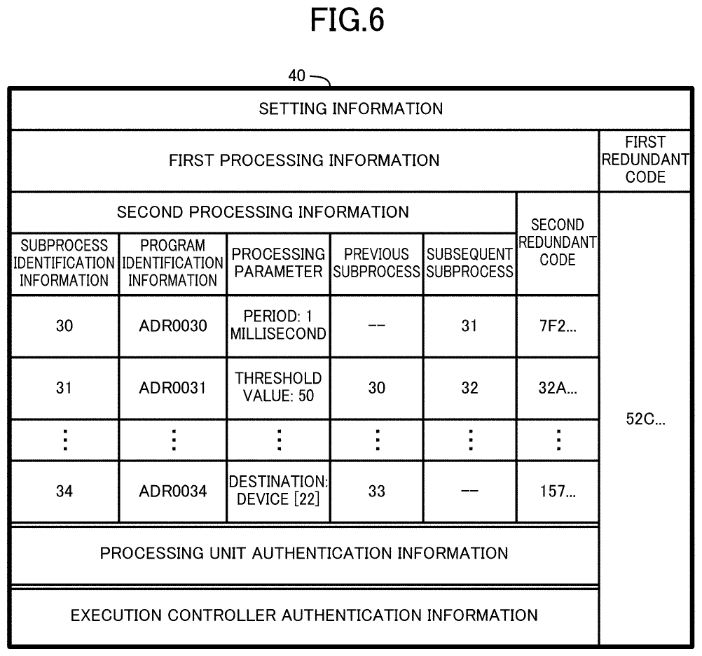

FIG. 6 illustrates an example of the setting information 40 in a table format. In the example illustrated in FIG. 6, the second processing information is information in which subprocess identification information for identification of a subprocess, program identification information for identification of a program to achieve the subprocess, a processing parameter that defines content of the subprocess, another subprocess that is to be executed previous to the subprocess, and still another subprocess that is to be executed subsequent to the subprocess, are associated. FIG. 6 illustrates, as the subprocess identification information, values that are equal to the numbers assigned to the subprocesses of FIG. 3. The program identification information is an address in the auxiliary storage 13 in which the software module for execution of the subprocess is stored. FIG. 6 illustrates, as a previous subprocess and a subsequent subprocess, identification information for each of the previous subprocess and the subsequent subprocess.

Again with reference to FIG. 4, the determiner 142 reads the setting information 40 from the storage 141 and determines whether the data processing indicated by the setting information 40 has the validity. Specifically, the determiner 142 determines whether the validity is present for the setting information 40, by calculating the first redundant code 42 from the first processing information 41 and determining whether the calculated first redundant code 42 matches the first redundant code 42 included in the setting information 40. Further, the determiner 142 determines whether the validity relating to the processing units 130 indicated by the pieces of the second processing information 411 is present, by calculating the second redundant codes 412 based on the pieces of the second processing information 411 and determining whether the calculated second redundant codes 412 match the second redundant codes 412 included in the setting information 40. The determiner 142, upon determining that the validity is present for the first processing information 41 and all of the pieces of the second processing information 411, sends notification of a result of the determination to the flow controller 143 and causes the flow controller 143 to execute the data processing. The determiner 142 is an example of determination means for determining, (i) based on comparison between a first redundant code and a first calculation code that is calculated from first processing information, whether a first validity is present for setting information and (ii) based on comparison between a second redundant code and a second calculation code that is calculated based on second processing information, whether a second validity relating to the processing units 130 and the collection processing units 160 is present.

The flow controller 143 transmits, to any one of the processing units 130 or the collection processing units 160, data acquired from any one of the processing units 130 or the collection processing units 160. For example, the flow controller 143 acquires, from the collection processing units 160, data collected by the collection processing units 160, and then the flow controller 143 transmits the data to the processing unit 131, thereby causing the processing unit 131 to execute the subprocess. Further, the flow controller 143, upon acquiring from one processing unit 130 data indicating a result of a corresponding subprocess, transmits this data to another processing unit 130 for execution of the subsequent subprocess, thereby causing the other processing unit 130 to execute the subsequent subprocess.

The flow controller 143, upon acquiring from the processing unit 133 data indicating a result of a corresponding subprocess, transmits this data, as a control command to be transmitted to the device 22, to the collection processing units 160. In a case in which output processing that is different from the transmission of the control command to the device 22 is defined as output of data processing, the flow controller 143 executes processing for achievement of the defined output processing. For example, in a case in which displaying on a screen the result of the data processing is defined, the flow controller 143 may transmit, to the outputter 15 including the LCD, data for displaying the result. The flow controller 143 is an example of control means, included in the data processing apparatus 10, for causing the processing units 130 and the collection processing units 160 to execute data processing.

The collection processing units 160 are mainly achieved by cooperation between the processor 11 and the communicator 16 and executes the subprocesses 30 and 34. Specifically, the collection processing units 160 are, similarly to the processing units 130, achieved by execution by the processor 11 of a software module stored in the auxiliary storage 13. Further, the collection processing units 160 transmit, to the execution controller 140, information that is repeatedly transmitted from the device 21, and transmit, to the device 22, the control command outputted by the execution controller 140. Multiple collection processing units 160 are provided correspondingly to types of industrial networks to which the data processing apparatus 10 is connected. Although FIG. 4 illustrates multiple collection processing units 160, in a case in which both of the devices 21 and 22 are connected to a single industrial network, single collection processing unit 160 may be connected to both of the devices 21 and 22. The collection processing unit 160 is a second example of the processing means, included in the data processing apparatus 10, for executing data processing.

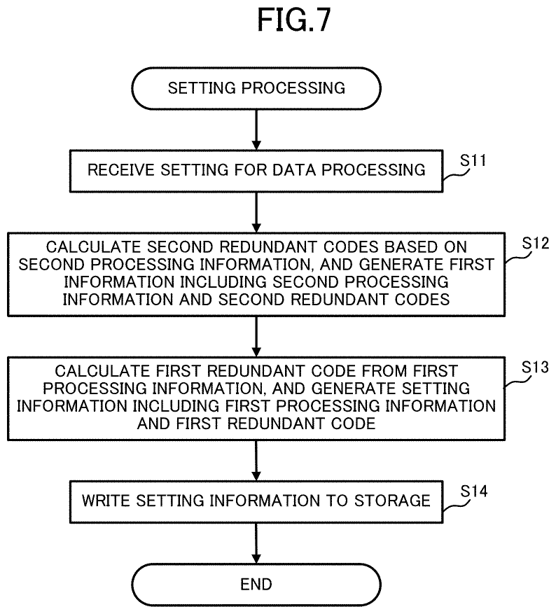

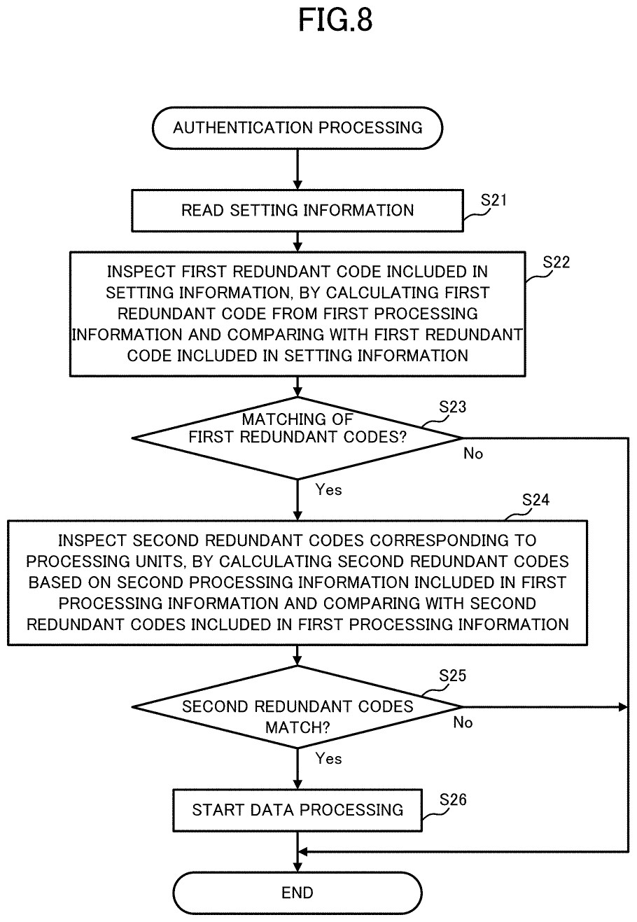

Next, processing executed by the data processing apparatus 10 is described with reference to FIGS. 7-8. Specifically, setting processing for generating the setting information including the redundant codes, and authentication processing for authenticating the validity of data processing based on the setting information, are described in that order.

In the setting processing, as illustrated in FIG. 7, the receiver 120 of the data processing apparatus 10 receives the setting for the data processing (step S11). Specifically, the receiver 120 receives information indicating content of data processing that is inputted by the user into the input device 101. The user inputs the content of the data processing by, for example, operating a graphical user interface (GUI) of the input device 101 and selecting objects corresponding to the subprocesses and linking together the objects using arrows as illustrated in FIG. 3. The content inputted by the user is a part or all of the second processing information 411 illustrated in FIG. 5.

Again with reference to FIG. 7, following step S11, the receiver 120 calculates the second redundant codes based on the second processing information, and generates the first processing information including the second processing information and the second redundant codes (step S12). Specifically, the receiver 120 calculates, for each piece of the second processing information, from binary data of a software module indicated by the piece of the second processing information, the second redundant code. Then the receiver 120 generates the first processing information by combining the pieces of the second processing information and the second redundant codes. Any method for combining the piece of the second processing information and the second redundant code may be employed, and the receiver 120 may add the second redundant code to the bottom of the piece of the second processing information, or may embed the second redundant code onto the piece of the second processing information. Further, the receiver 120 may calculate the second redundant code after preparing the second processing information by adding information to the setting received in step S11. For example, in a case in which a parameter for a subprocess that is to be set by the user is not inputted, the receiver 120 may compensate by using a default parameter that is predefined.

Then the receiver 120 calculates the first redundant code from the first processing information, and generates the setting information including the first processing information and the first redundant code (step S13). The method for calculating in step S12 the second redundant code and the method for calculating in step S13 the first redundant code may be similar to each other or may be different. For example, the receiver 120 may calculate a cyclic redundant code as the second redundant code and calculate a hash value as the first redundant code.

Then the receiver 120 writes the setting information generated in step S13 to the storage 141 of the execution controller 140 (step S14). Due to this, the content of the data processing that is inputted by the user is set in a state that enables verification of the validity for the content. Thereafter, the setting processing ends. Generating the setting information including the redundant codes at a stage of receiving by the receiver 120 the setting enables performing, in the authentication processing, verification as to whether alteration of data is made thereafter. The setting processing is an example of a receiving step of receiving, by the receiver 120, a setting for data processing to be executed with respect to data and writing, by the receiver 120, to the storage 141 setting information indicating the setting.

Next, the authentication processing for authenticating the validity of the data processing is described with reference to FIG. 8. The authentication processing illustrated in FIG. 8 starts in response to input of an instruction to start the data processing. In the authentication processing, as illustrated in FIG. 8, the determiner 142 reads the setting information from the storage 141 (step S21).

Then the determiner 142 inspects the first redundant code included in the setting information, by calculating the first redundant code from the first processing information included in the setting information read in step S21 and comparing the calculated first redundant code with the first redundant code included in the setting information (step S22). The method for calculating the first redundant code is similar to the calculation method in step S13 of the setting processing illustrated in FIG. 7. The first redundant code calculated in this step S22 is an example of the first calculation code that is compared with the first redundant code that is stored in the storage 141 in the setting processing.

Then the determiner 142 determines whether the calculated first redundant code match the first redundant code included in the read setting information (step S23). When a determination is made that the first redundant codes do not match (NO in step S23), the data processing apparatus 10 determines that the setting information does not have the validity and ends the authentication processing without starting the data processing. Since computational load for calculating a redundant code is relatively small, the data processing apparatus 10 can easily evaluate the validity for the setting information and avoid execution of data processing indicated by the setting information that does not have the validity.

Conversely, when a determination is made that the first redundant codes match (YES in step S23), the determiner 142 inspects the second redundant codes corresponding to the processing units 130, by calculating the second redundant codes based on the pieces of the second processing information included in the first processing information and comparing the calculated second redundant codes with the second redundant codes included in the first processing information (step S24). The method for calculating the second redundant code is similar to the calculation method in step S12 of the setting processing illustrated in FIG. 7. The second redundant code calculated in this step S24 is an example of the second calculation code that is compared with the second redundant code that is stored in the storage 141 in the setting processing.

Then the determiner 142 determines whether all of the calculated second redundant codes match the second redundant codes included in the first processing information (step S25). The determinations made in step S23 and step S25 correspond to an example of a determination step of determining, by the determiner 142, (i) whether the first validity is present for the setting information and (ii) whether the second validity relating to the processing units 130 and the collection processing units 160 is present. When a determination is made that the second redundant codes do not match (NO in step S25), the data processing apparatus 10 determines that the validity relating to the processing units 130 and the collection processing units 160 for execution of the subprocesses indicated by the setting information is not present, and ends the authentication processing without starting the data processing. Since computational load for calculating a redundant code is relatively small, the data processing apparatus 10 can easily evaluate the validity relating to the processing units 130 and the collection processing units 160 and avoid execution of data processing by a processing unit 130 that does not have the validity.

Conversely, when a determination is made that all of the second redundant code match (YES in step S25), the determiner 142 sends to the flow controller 143 notification indicating completion of authentication, and the flow controller 143, upon receipt of this notification, starts the data processing indicated by the setting information (Step S26). This data processing is an example of a control step of causing, by the flow controller 143, the processing units 130 and the collection processing units 160 to execute data processing. Thereafter, the authentication processing ends.

As described above, the determiner 142 determines whether the validity is present for the setting information, and determines whether the validity relating to the processing units 130 is present. Due to this configuration, even in a case in which alteration is made for the setting information or the programs for achievement of the processing units 130 while a state of ensuring one validity is maintained, a determination on whether the other validity is present is made, thereby ensuring the validity of the content of processing. This enables more reliable ensuring of the validity of processing to be executed with respect to data.

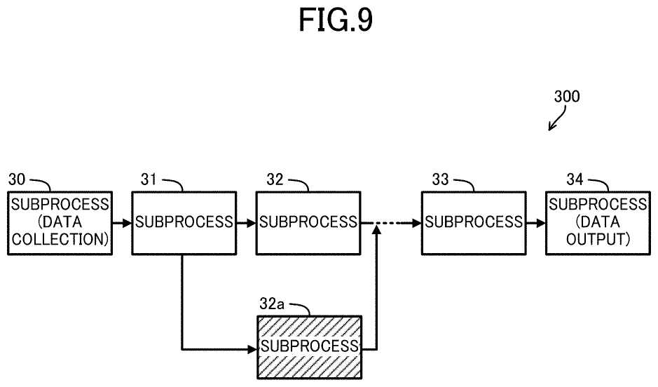

Specifically, a case is assumed in which, after the receiver 120 receives the data processing 300 illustrated in FIG. 3 and the setting information is stored in the storage 141, the content of the first processing information and second processing information is rewritten to be invalid data processing as illustrated in FIG. 9. According to this invalid data processing, a result of the subprocess 31 is outputted to the subprocess 32 and to a newly-inserted invalid subprocess 32a, and a result of execution of the subprocesses 32 and 32a is inputted to the subprocess 33. In the case in which the setting information is modified as described above, the inclusion in data processing of an invalid subprocess, that is, the subprocess 32a, is detected prior to execution of the data processing. This enables avoidance of execution of invalid processing.

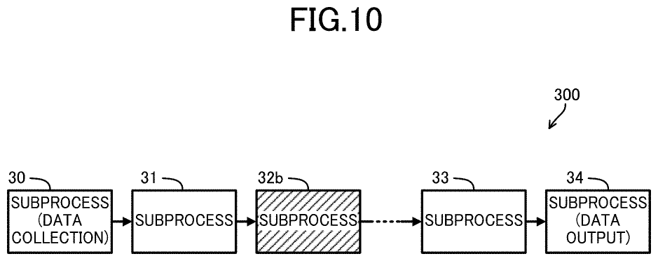

Furthermore, a case is assumed in which, after the data processing 300 illustrated in FIG. 3 is set, the content of the first processing information and second processing information is rewritten to be invalid data processing as illustrated in FIG. 10. In this invalid data processing, the subprocess 32 is rewritten to be a subprocess 32b. In the case in which the setting information is modified as described above, the inclusion in data processing of an invalid subprocess, that is, the subprocess 32b, is detected prior to execution of the data processing. This enables avoidance of execution of invalid processing.

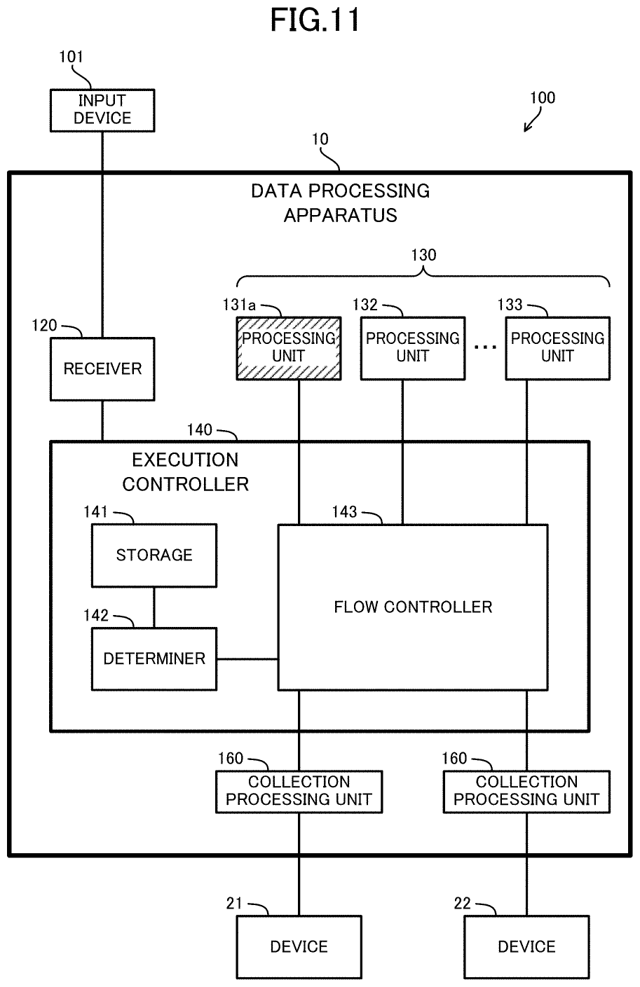

Furthermore, a case is assumed in which no alteration is made for the setting information while alteration is made for the program for achievement of the processing unit 131 and, as illustrated in FIG. 11, a processing unit 131a appears instead of the processing unit 131. Even in this case, since the second redundant codes are calculated from the binary data for execution of the subprocesses, verifying the second redundant codes leads to, prior to execution of data processing, detection that the subprocess 31 to be executed by the processing unit 131 does not have the validity.

### Embodiment 2

Next, Embodiment 2 is described with focus on differences from aforementioned Embodiment 1. In the present embodiment, components that are the same or equivalent to those of aforementioned Embodiment 1 are denoted with the same reference signs, and explanation for such components is omitted or simplified. A data processing apparatus 10 according to the present embodiment generates a redundant code depending on an authorization level of the user, which differentiates the present embodiment from Embodiment 1. The data processing apparatus 10, when data processing is set by a user having an appropriate authorization level for setting, determines that processing to be executed has the validity, or when data processing is set by a user not having the authorization level for setting, determines that processing to be executed does not have the validity.

The data processing apparatus 10 receives a setting for data processing that is inputted by operation by the user of the input device 101. The input device 101, by executing software installed therein, provides functions as a setting tool for the user to set the data processing. This setting tool includes determination information indicating an algorithm for calculating a redundant code and for determination on whether the validity is present. The data processing apparatus 10 performs verification of the validity by calculating a redundant code by utilizing an algorithm provided by the input device 101, and comparing redundant codes prior to execution of the data processing by utilizing this algorithm.

An authorization level is set for a user to use the setting tool. For example, a process manager is given the authorization level for setting and is allowed to set data processing. Conversely, a worker in the workplace is not given the authorization level for setting and is not allowed to modify the setting for data processing.

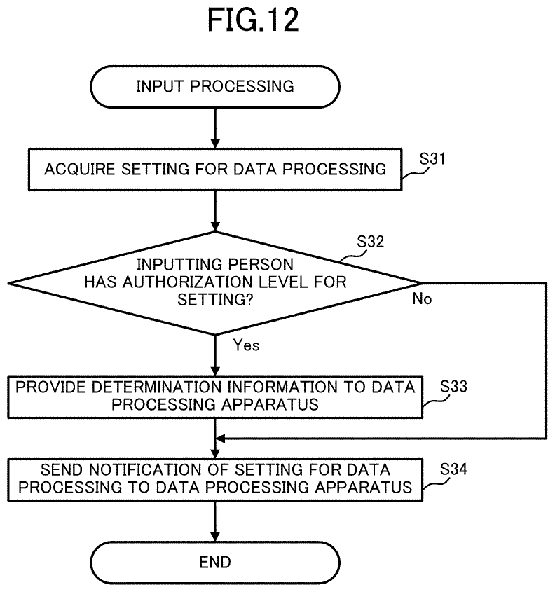

FIG. 12 illustrates input processing executed by the input device 101. As illustrated in FIG. 12, in the input processing, the input device 101 acquires the setting for the data processing that is inputted by the user (step S31).

Then the input device 101 determines whether an inputting person that is the user having inputted the setting in step S31 has the authorization level for setting (step S32). When a determination is made that the inputting person does not have the authorization level for setting (NO in step S32), the input device 101 shifts the processing to step S34. Conversely, when a determination is made that the inputting person has the authorization level for setting (YES in step S32), the input device 101 provides to the data processing apparatus 10 the determination information that is used for determining, by comparison of redundant codes, whether the validity is present (step S33). The determination information is, for example, data indicating the algorithm for calculating a redundant code.

Then the input device 101 sends, to the data processing apparatus 10, notification of the setting for the data processing that is acquired in step S31 (step S34). Thereafter, the input processing ends.

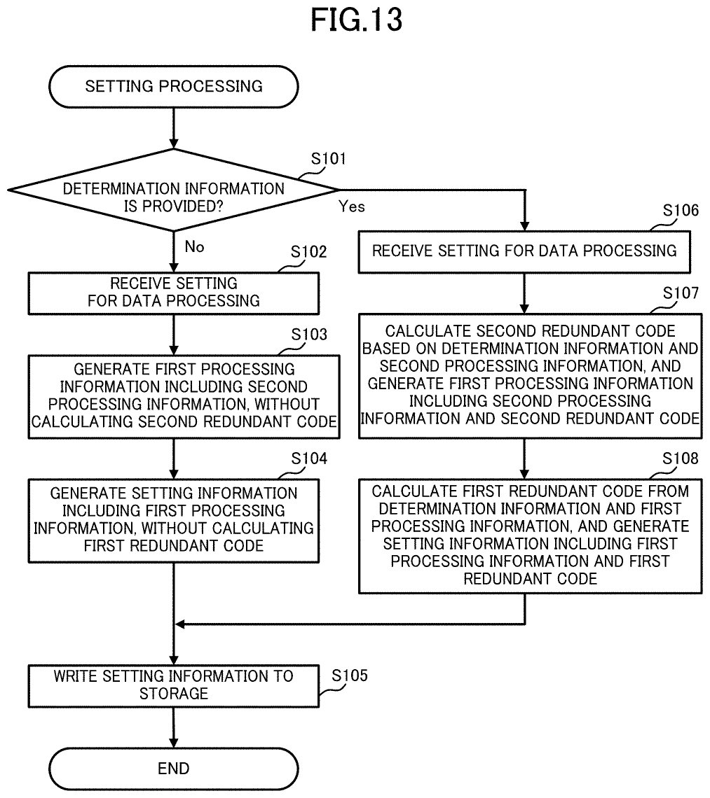

FIG. 13 illustrates the setting processing executed by the data processing apparatus 10. As illustrated in FIG. 13, in the setting processing, the data processing apparatus 10 determines whether the determination information is provided by the input device 101 (step S101). Specifically, the receiver 120 determines whether the determination information is received from the input device 101.

When a determination is made that the determination information is not provided, (NO in step S101), the data processing apparatus 10 receives the setting for the data processing (step S102). Processing executed in this step is equivalent to that executed in step S11 illustrated in FIG. 7.

Then the data processing apparatus 10 generates the first processing information including the second processing information, without calculating the second redundant code (step S103). This step corresponds to step S12 illustrated in FIG. 7. In this step S103, empty data or zero-padded data may be embedded in the first processing information as the second redundant code.

Then the data processing apparatus 10 generates the setting information including the first processing information, without calculating the first redundant code (step S104). This step corresponds to step S13 illustrated in FIG. 7. In this step S104, empty data or zero-padded data may be embedded in the setting information as the first redundant code.

Then the data processing apparatus 10 writes the setting information to the storage 141 (step S105). This step corresponds to step S14 illustrated in FIG. 7. Thereafter, the setting processing ends.

When a determination is made in step S101 that the determination information is provided, (YES in step S101), the data processing apparatus 10 receives the setting for the data processing (step S106). Processing executed in this step is equivalent to that executed in step S102.

Then the data processing apparatus 10 calculates the second redundant code based on the provided determination information and the second processing information, and generates the first processing information including the second processing information and the second redundant code (step S107). This step corresponds to step S12 illustrated in FIG. 7.

Then the data processing apparatus 10 calculates the first redundant code from the provided determination information and the first processing information, and generates the setting information including the first processing information and the first redundant code (step S108). This step corresponds to step S13 illustrated in FIG. 7. Thereafter, the data processing apparatus 10 shifts the processing to step S105.

When executing the data processing, the data processing apparatus 10 executes the authentication processing illustrated in FIG. 8. In the authentication processing according to the present embodiment, the determiner 142 determines whether the validity is present based on the determination information received by the receiver 120 from the input device 101. In a case in which the determination information is not provided in the setting processing, the determination in step S23 is negative since calculating the first redundant code from the setting information is unachievable, and thus the authentication processing ends without executing data processing.

As described above, the redundant code is calculated based on the determination information that is provided depending on an authorization level of the user. Thus, when data processing is set by a user having a proper authorization level, the set data processing is executed, or when data processing is set by a user not having the proper authority level, the set data processing is not executed. This configuration enables detection of whether data processing is set by a user not having the authorization level. A configuration may be employed in which, when data processing is set by a user not having the authorization level, the data processing apparatus 10 executes the set data processing upon confirmation by the manager.

In a typical workplace, a worker not having the authorization level handles the data processing apparatus 10. Thus, a case is assumed in which the worker attempts to set data processing by utilizing another tool other than the tool provided by the input device 101. However, since the other tool does not include the determination information, the attempt by the worker to set data processing by utilizing the other tool leads to failure to calculate an appropriate redundant code. This enables avoidance of execution of data processing that is set by the worker not having the authorization level.

Although the worker not having the authorization level can rewrite binary data or text data of the setting information stored in the data processing apparatus 10, adding a redundant code corresponding to rewritten content of the setting is unachievable. This configuration enables, in the authentication processing, determination that the setting information is modified by the user not having the authorization level.

The determination information is not limited to information indicating an algorithm, and may be other information necessary for determination on whether the validity is present.

The determination information may provide different information for the first redundant code and the second redundant code. For example, an algorithm that is indicated by the determination information for calculating the first redundant code may be different from an algorithm that is indicated by the determination information for calculating the second redundant code.

Although embodiments of the present disclosure are described above, the present disclosure is not limited to the aforementioned embodiments.

For example, although the second redundant code is calculated from binary data of the software module for achievement of the processing unit 130, this configuration is not limiting. For example, the second redundant code may be calculated from the second processing information or may be calculated from the binary data and the second processing information.

In particular, calculating a redundant code for each subprocess from the second processing information specifying the previous subprocess and the subsequent subprocess that are prior to and subsequent to the subprocess enables ensuring the validity of the subprocess while ensuring the validity for a sequencing of the subprocess with respect to the previous subprocess and the subsequent subprocess.

Furthermore, in order to improve tamper resistance, the setting information may be generated by embedding in the first processing information a randomly-selected bit value in addition to the first redundant code, or by embedding in the second processing information a randomly-selected bit value in addition to the second redundant code. According to this configuration, altering the first redundant code and the second redundant code while altering the setting information is difficult, and performing verification for these redundant codes enables more reliable ensuring of the validity of data processing.

Furthermore, although the aforementioned embodiments describe calculating the first redundant code from the first processing information and calculating the second redundant code from the second processing information, at least one of the first redundant code or the second redundant code may be calculated from data including the authentication information that is set by the user in the setting processing. For example, a configuration may be employed in which, in the setting processing, the user inputs an authentication code, the first redundant code is calculated from the first processing information and the authentication information, and the second redundant code is calculated from the second processing information and the authentication information, and in the authentication processing, a request for inputting the authentication information is made to the user and verification is performed by calculating the first redundant code and the second redundant code by utilizing the inputted authentication information. Utilizing the authentication information makes altering the first redundant code and the second redundant code difficult, and thus enables more reliable ensuring of the validity of data processing. Further, the authentication information may be information that is different from the information inputted by the user. For example, the redundant codes may be calculated by utilizing authentication information provided by an authentication server.

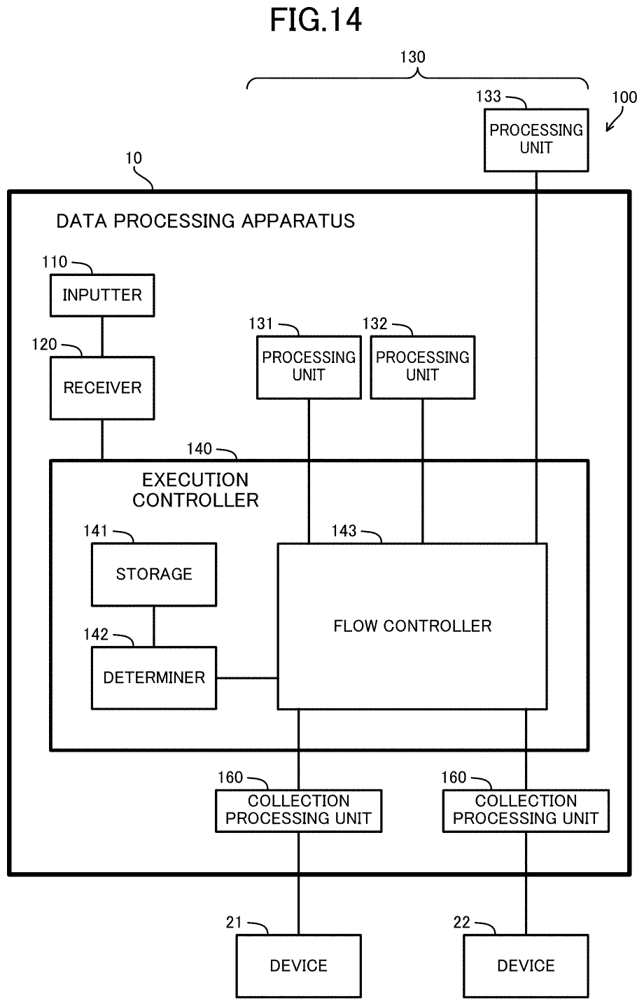

The aforementioned embodiments describe connecting the input device 101 to the data processing apparatus 10. This connection may be a connection by a network cable or a dedicated line, or may be a connection via the network 20. Further, the data processing apparatus 10 need not be connected to the input device 101 and instead may include an inputter 110 that allows the user to input information, as illustrated in FIG. 14. Further, the data processing system 100 may include the processing unit 133 outside the data processing apparatus 10.

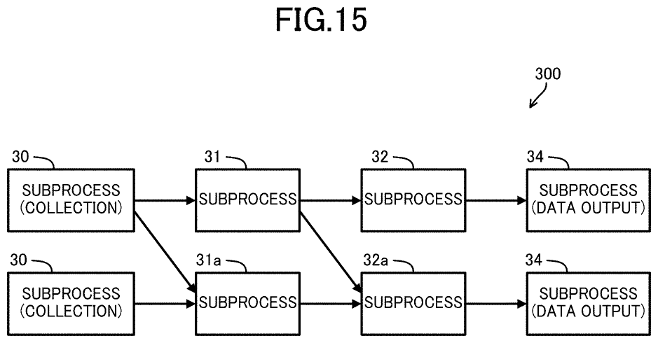

Furthermore, although the aforementioned embodiments describe an example of relatively simple data processing as illustrated in FIG. 3, this is not limiting, and the data processing may be complicated. For example, the data processing may, as illustrated in FIG. 15, branch from the subprocess 30 into the subprocess 31 and a subprocess 31a, and converge from the subprocesses 31 and 31a into a subprocess 32a. Further, although the aforementioned embodiments describe in FIGS. 5 and 6 an example in which the setting information includes the processing unit authentication information and the execution controller authentication information, the setting information may be generated while omitting the processing unit authentication information and the execution controller authentication information.

Furthermore, the functions of the data processing apparatus 10 can be achieved by dedicated hardware or by a normal computer system.

For example, distributing the program P1 to be executed by the processor 11 by storing the program P1 in a non-transitory computer-readable recording medium and then installing the program P1 on a computer can achieve a device for executing the aforementioned processing. A flexible disk, a compact disc read-only memory (CD-ROM), a digital versatile disc (DVD), and a magneto-optical (MO) disc are conceivable as examples of such a recording medium.

Furthermore, the program P1 may be stored in a disk device included in a server device on a communication network such as the Internet and may be downloaded onto a computer by, for example, superimposing the program P1 on a carrier wave.

Furthermore, the aforementioned processing can also be achieved by starting and executing the program P1 while transferring the program P1 through the communication network.

Furthermore, the aforementioned processing can also be achieved by executing all or a portion of the program P1 on the server device and by executing, using the computer, a program while transmitting and receiving information relating to the processing via the communication network.

In the case in which the aforementioned functions are implemented by an operating system (OS) by allocation to the OS or are implemented by cooperation between the OS and an application, storage and distribution on the medium of only portions of the program P1 other than a portion of the program P1 executed by the OS is permissible. Alternatively, such portions of the program P1 may be downloaded to a computer.

Furthermore, means for achieving the functions of the data processing apparatus 10 is not limited to software, and a part of or all of the functions may be achieved by dedicated hardware including a circuit.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### INDUSTRIAL APPLICABILITY

The present disclosure is suitable for data processing.

### REFERENCE SIGNS LIST

100 Data processing system
10 Data processing apparatus
11 Processor
12 Main storage
13 Auxiliary storage
14 Inputter
15 Outputter
16 Communicator
17 Internal bus
101 Input device
110 Inputter
120 Receiver
130-133, 131a Processing unit
140 Execution controller
141 Storage
142 Determiner
143 Flow controller
160 Collection processing unit
20 Network
21, 22 Device
300 Data processing
30-34, 31a, 32a, 32b Subprocess
40 Setting information
41 First processing information
411 Second processing information
412 Second redundant code
413 Processing unit authentication information
414 Execution controller authentication information
42 First redundant code
P1 Program

1. A data processing apparatus comprising:
a receiver to receive a setting for data processing to be executed with respect to data;
a storage to store setting information that includes first processing information indicating the setting received by the receiver and a first redundant code corresponding to the first processing information, the first processing information including second processing information relating to a processing unit for execution of the data processing and a second redundant code corresponding to the second processing information;
a determiner to determine, based on comparison between the first redundant code and a first calculation code that is calculated from the first processing information, whether a first validity is present for the setting information, and to determine, based on comparison between the second redundant code and a second calculation code that is calculated based on the second processing information, whether a second validity relating to the processing unit is present; and
a controller to transmit data to the processing unit when the determiner determines that the first validity is present and the second validity is present, thereby causing the processing unit to execute the data processing, wherein
the receiver generates the setting information by calculating the first redundant code from the first processing information and writes the generated setting information to the storage.

2. (canceled)

3. (canceled)

4. (canceled)

5. The data processing apparatus according to claim 1, wherein the second calculation code is calculated from a program for implementation of the processing unit.

6. A data processing apparatus comprising:
a receiver to receive a setting for data processing to be executed with respect to data;
a storage to store setting information that includes first processing information indicating the setting received by the receiver and a first redundant code corresponding to the first processing information, the first processing information including second processing information relating to a processing unit for execution of the data processing and a second redundant code corresponding to the second processing information;
a determiner to determine, based on comparison between the first redundant code and a first calculation code that is calculated from the first processing information, whether a first validity is present for the setting information, and to determine, based on comparison between the second redundant code and a second calculation code that is calculated based on the second processing information, whether a second validity relating to the processing unit is present; and
a controller to transmit data to the processing unit when the determiner determines that the first validity is present and the second validity is present, thereby causing the processing unit to execute the data processing, wherein
the receiver generates the setting information by calculating the second redundant code based on the second processing information and writes the generated setting information to the storage.

7. A data processing apparatus comprising:
a receiver to receive a setting for data processing to be executed with respect to data;
a storage to store setting information that includes first processing information indicating the setting received by the receiver and a first redundant code corresponding to the first processing information, the first processing information including second processing information relating to a processing unit for execution of the data processing and a second redundant code corresponding to the second processing information;
a determiner to determine, based on comparison between the first redundant code and a first calculation code that is calculated from the first processing information, whether a first validity is present for the setting information, and to determine, based on comparison between the second redundant code and a second calculation code that is calculated based on the second processing information, whether a second validity relating to the processing unit is present; and
a controller to transmit data to the processing unit when the determiner determines that the first validity is present and the second validity is present, thereby causing the processing unit to execute the data processing, wherein
the receiver receives determination information that is to be used for determining whether the first validity is present and whether the second validity is present, and
the determiner determines, based on the determination information, determines whether the first validity is present and whether the second validity is present.

8. (canceled)

9. (canceled)
